(19) United States
(12) Patent Application Publication
(10) Pub. No.: US 2002/0074742 A1
(43) Pub. Date: Jun. 20, 2002

(54) Metallic seal components

(76) Inventor: Roberto L. Quoiani, Dunfermline (GB)

Correspondence Address: Henry C. Query, Jr., 504 S. Pierce Avenue, Wheaton, IL, 60187, US

(21) Appl. No.: 10/010,427

(22) Filed: Nov. 30, 2001

(30) Foreign Application Priority Data
Dec. 20, 2000 (GB) GB 00 31152.2

(51) Int. Cl. F16J 15/08

(52) U.S. Cl. 277/627

(57) ABSTRACT

Shape memory alloy (SMA) technology and bi-metallic sealing elements are used to provide compact, reliable super-elastic sealing mechanisms, e.g., for use in the oilfield environment. Novel designs for sealing of annular areas are presented.

### BACKGROUND OF THE INVENTION

This invention relates to metallic seals and seal components which are energized in a novel manner, which have improved reliability and which can be made smaller than conventional metal-to-metal seals. Although for illustrative purposes the invention is discussed below largely in the context of completions for oil and gas wells, it is applicable to metallic seals in general, for dynamic as well as static uses.

There is a trend towards subsea completions incorporating increasingly larger bores. Current subsea xmas tree system configurations (both parallel and concentric) can be inefficient in terms of space usage within the tubing hanger assembly. For large completion bore systems it would be advantageous to reconfigure the subsea xmas tree system whilst maintaining a large number of down-hole lines through the tubing hanger. A solution for releasing additional radial space to facilitate larger completion bores would be to reduce the size of the mechanism for sealing off the annulus void.

The design of large bore subsea xmas trees and completions is constrained due to requirements of utilizing existing standard BOP configurations. Therefore in order to run larger completion tubing, space must be saved elsewhere to permit using existing BOP'S. Additionally, particularly in the case of deepwater developments, significant cost savings can be achieved by using smaller standard BOP and casing programs while still maintaining—or increasing—the radial space available for the completion tubing. In this way vessel selection is made easier, and hence costs decreased, due to smaller handling requirements associated with the smaller BOP size.

The problematic situation of a drive toward larger bore completions coupled with potentially utilizing smaller BOP stacks makes the radial space taken within the well system for annular packoffs of prime importance. Any space saved here can have a direct impact on the size of the completion tubing that can be accommodated.

Essentially, the sealing requirement for a slick bore tubing hanger is to seal the annulus between the tubing hanger and spool (wellhead, xmas tree or tubing spool), maintaining a clearance while running in the hanger, and once the hanger is in position, energizing the seal to a set (sealed) condition. In the particular case of horizontal production outlet tubing hangers, it is usual to seal the annulus above and below the horizontal outlet. In the case of conventional tubing hangers (or casing hangers), only one seal barrier is required to seal off the annulus.

The prior art is replete with descriptions of seal systems involving a metal seal element that bears against a metallic surface to establish a metal-to-metal sealing interface preventing the passage of corrosive or non-corrosive pressurized fluid throughout a wide temperature and pressure range. Although many of these seals have been employed successfully, most have limitations that preclude satisfactory performance under a combination of unusual and relatively severe conditions occurring, for example, when the seal area is subject to cyclical loading, extreme pressure changes and/or large thermal movements. Accordingly, as well as a more compact seal arrangement, there exists a need for a reliable metal-to-metal seal system that will function both statically and dynamically to prevent the escape of fluids.

Packoffs providing metal-to-metal seals are disclosed for example in U. S. Pat. Nos. 4,900,041 and 5,174,376. Both of these patents disclose annular metal seal elements having a generally U-shaped cross-section. The seal elements concerned are expanded and set by energizing mandrels which incorporate resilient portions, designed to deform elastically on setting. This provides stored energy (potential energy) that can be used to maintain the seal contact forces in the event of slight relative movements between the mandrel, seal element and its co-operating sealing surface. However such mechanisms can fail to prevent leakage under the severe conditions mentioned above.

### SUMMARY OF THE INVENTION

The invention lies in the realization that a particular class of alloys may be used to provide metallic seals which are more reliable under extreme conditions than prior metal-to-metal seals. Accordingly, the invention provides a metallic seal component comprising an alloy which in use exhibits super-elastic properties.

Super-elasticity is a property exhibited by shape memory alloys and similar metallic materials. The crystalline lattice structure of a shape memory alloy (SMA) changes from the austenitic form at higher temperatures to the martensitic form at lower temperatures. The austenitic form of the alloy is typically much stronger than the martensitic form. In the martensitic form, the alloy can be easily worked to attain new geometries. However, the original shape can be recovered by heating the alloy above its phase transformation temperature to produce austenite. During this process, the alloy will impart a considerable force against anything resisting the change back to the original geometry. Hence the name shape memory. Super-elasticity is a further property of shape memory alloys and similar materials. When a stress load is applied to these materials at just above the phase transformation temperature, the austenite is progressively changed to the more easily deformable martensite. Considerable deformations can therefore be produced for only relatively modest increases in applied stress. When the load is removed, the martensite changes back to austenite, and the original geometry is recovered. During this loading/unloading process, these materials therefore behave elastically, but with a remarkably low Young's modulus. Such materials are sometimes referred to as “pseudo-elastic”, as the phenomenon only occurs at the right temperatures and over a particular region of the stress-strain curve.

By careful modification of the chemistry and crystalline structure of the alloys, the transformation temperature can be altered to meet design requirements. The phase transformation can be controlled so as to take place over a sharply defined temperature range of only a few degrees Centigrade. Also, the absolute temperature at the start or end point of this range can be accurately adjusted, perhaps by up to several hundred degrees Centigrade.

Materials that exhibit shape memory only upon heating are referred to as having a one-way shape memory. A special class of SMA's also undergoes a change in shape upon re-cooling. Such alloys are referred to as two-way shape memory alloys (TWSMA).

Although a relatively wide variety of alloys are known to exhibit the shape memory effect, only those that can recover substantial amounts of strain or that generate significant force upon changing shape are of commercial interest. To date, this has been the nickel-titanium alloys and copper-base alloys such as CuZnAl and CuAINi.

A typical stress-strain curve for a super-elastic metal alloy is shown in FIG. 1. Over the range a-b, a large change in strain can occur at relatively constant stress levels. In this range, as stress is applied the austenite to martensite transformation occurs, absorbing potential energy. The mechanical strain energy input (and hence the applied stress increment) required to effect a given strain increment is reduced. As the austenite to martensite transformation is reversible upon release of the applied stress, the material continues to behave elastically in the pseudo-elastic region a-b, but with a much reduced Young's modulus.

The super-elastic nature of the seal component of the present invention permits the generation of near constant sealing contact loads even under differing strains. Therefore metallic components such as energizing mandrels, seal backup springs, or a sealing element or its co-operating surface, that have been stressed into the pseudo-elastic region to maintain a sealing contact load, may move or deform significantly without disrupting this stress. At the level of the crystal structure, the potential energy that in the prior art is stored as mechanical strain energy in order to maintain the sealing contact, is instead partly stored and released in the austenite—martensite—austenite transformation, meaning that much larger strains can be accommodated without disrupting the required sealing contact forces. The overall effect of this is that the components are elastically “softer”. Thus, for example, an energizing mandrel made of pseudo-elastic SMA can continue to exert a near constant load on the sealing element even under differing strains—i.e., the mandrel may move due to settling or thermal effects; however the load exerted on the sealing element will not be significantly affected. Similarly, a sealing element or seal ring of pseudo-elastic SMA will be much more softly elastic (have a lower Young's modulus) and hence much more able to accommodate strain and movement than a metallic sealing element of the prior art. Such sealing elements are therefore much more reliable under extreme conditions.

The stressing required to maintain the pseudo-elasticity and sealing contact forces can be generated by any suitable conventional means, such as hydraulically, by adjustment nuts and other mechanical wedging arrangements, by weight or simply by force fits. Pseudo-elasticity is a property of SMA's that occurs isothermally at slightly above the transformation temperature. The ability of SMA's to change shape on heating or cooling (shape memory), also discussed above, is a separate property that can be independently exploited to provide an alternative means for energizing seal components.

Advantageously, the invention may therefore provide a seal component that in use changes its shape or size between an energized, seal enabling state and a released, unsealed state, the change of shape or size being effected by heating or cooling.

In addition to being made in whole or in part from an SMA (ether one-way or two-way), the seal component could also have a bimetallic construction. In the energized condition, the component is preferably stressed so as to generate a sealing contact force. The thermo-mechanical properties of the component are preferably selected so that this stress and hence the sealing contact force arises under ambient conditions when the component is in use. Because the seal component is thermally energized, it requires no bulky actuators such as adjustment nuts or hydraulic chambers. The seal assembly in which the component is accommodated may therefore be made much more compact than seal assemblies of the kind requiring external actuators for energization.

In its preferred forms, the invention allows seal components and assemblies to be produced that meet some or all of the following objectives:

1. To provide reliability under cyclical loading and wide pressure variations.

2. To accommodate 10,000 psi (69 MNm^{31 2}) nominal maximum working pressure as a typical base case. However, a family of such seal assemblies may be produced, also including, for example, members for 5,000 psi (35 MNm⁻²), 15,000 psi (104 MN⁻² ) and other applications as required.

3. Effective over a temperature range of at least 0° F. to 250° F. (−17.8° C. to 121° C.) and beyond at either end.

4. To utilize the principles of shape memory alloys (SMA) to effect a reliable seal.

5. To provide a compact seal assembly.

These and other objects and advantages of the present invention will be made apparent from the following detailed description, with reference to the accompanying drawings.

### BRIEF DESCRIPTION OF THE DRAWINGS

FIG. 1 shows, as mentioned above, a typical stress-strain curve for a pseudo-elastic material;

FIG. 2 is a diagrammatic representation of a metal-to-metal seal assembly using a pseudo-elastic energizing mandrel;

FIG. 3 diagrammatically represents, in two different states, a metal-to-metal seal assembly that uses a shape memory alloy sealing element;

FIG. 4 is a diagram of another embodiment of the invention having an SMA sealing element;

FIG. 5 diagrammatically shows, in three different states, an embodiment using a bimetallic sealing element; and

FIGS. 6 and 7 indicate possible modified forms of SMA sealing elements embodying the invention.

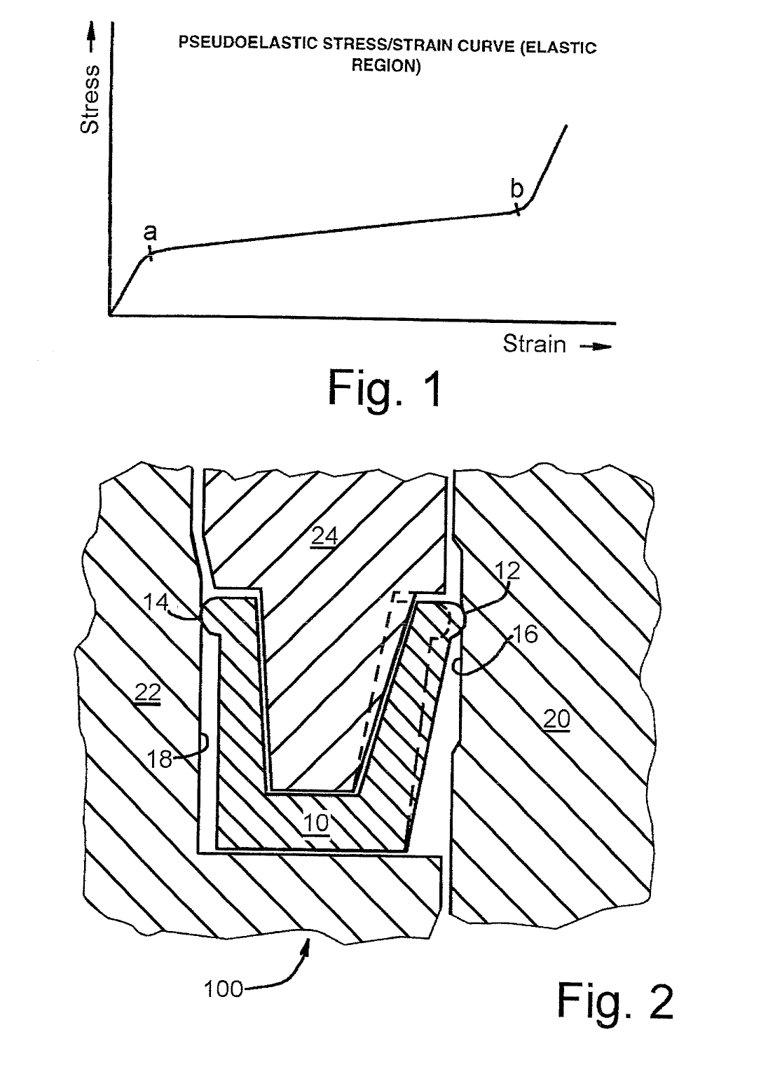

### DETAILED DESCRIPTION OF THE PREFERRED EMBODIMENTS

The present invention advantageously seeks to overcome the unreliability of known energized metal seals attributable to their inability to store energy in the system to cope with movement of any of the components. Preferably, it comprises a metallic sealing system utilizing shape memory alloys that when properly installed between two metallic surfaces, such as between a tubing hanger and well system, will establish and maintain a metal-to-metal fluid-tight sealing system between said surfaces under both static and dynamic conditions, in the presence of corrosive materials, and during and after exposure to a wide range of temperatures and/or large pressure fluctuations.

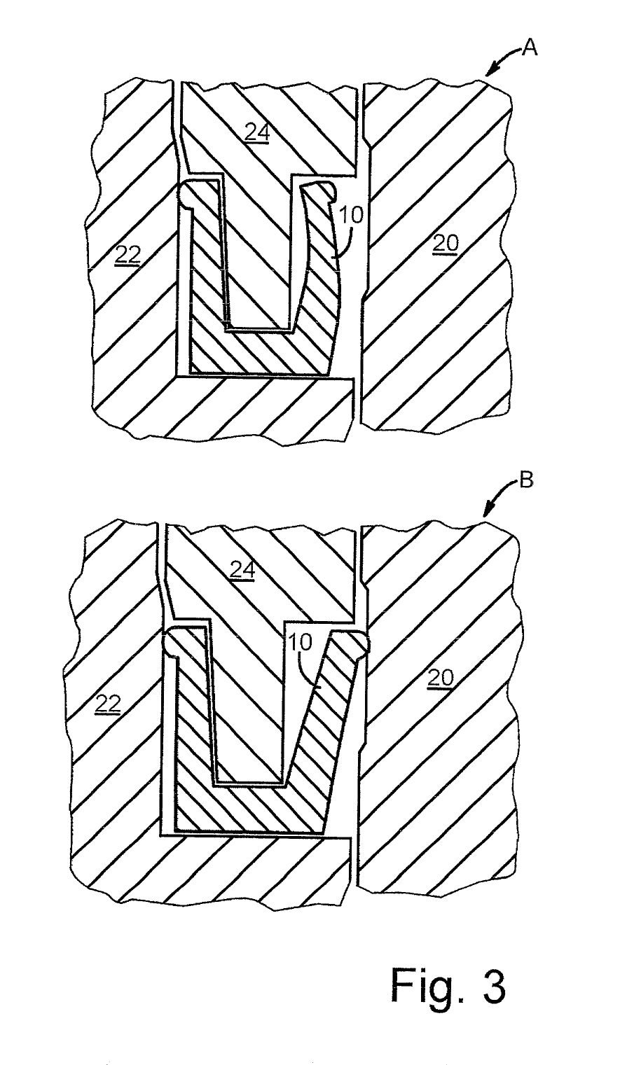

In the embodiment illustrated in FIG. 2, a sealing assembly 100 comprises a sealing element in the form of an annular metallic ring 10 of generally U-shaped cross-section. At least one sealing bump 12 is provided around its outer periphery and at least one sealing bump 14 around its inner bore, at the tips of the limbs of the U-shaped cross-section. The bumps 12, 14 are sealingly engageable with co-operating seal surfaces 16, 18 provided for instance on a well system spool 20 (wellhead housing, xmas tree or tubing spool) and a tubing hanger 22, respectively. The surfaces of the bumps can be angular, arcuate or otherwise curved, or can comprise both angular and curved configurations, and the number of bumps can be increased as desired and/or spaced along the limbs of the U-shaped cross-section.

The sealing assembly further comprises an energizing mandrel 24 made from an SMA. Prior to installation, and as the tubing hanger 22 and mandrel 24 with attached sealing ring 10 are run in hole, the tip of the mandrel may be in a crushed condition, with the outer limb of the seal ring in the dotted line position as shown. In this state, there is sufficient clearance for installation of the seal ring 10 adjacent to the sealing surface 16. During installation, the SMA energizing mandrel is heated, causing it to change from the weaker, low temperature form (Martensite) to the stronger, high temperature form (Austenite). Its tip thereby reverts to its original, uncrushed state, forcing the limbs of the sealing ring apart and into tight sealing engagement with the surfaces 16, 18 (their full line positions as shown). Compressive stresses are thereby set up in the mandrel tip and sealing ring limbs which generate sealing contact forces between the bumps 12, 14 and the sealing surfaces 16, 18.

The localized heating necessary for proper installation of certain of the sealing elements described herein may be achieved for example by electric resistance or induction heating and may require a high-current capacity electrical coupling between the surface and the sealing element.

Alternatively, the mandrel tip need not be pre-crushed, and heat need not be applied. Instead, the mandrel tip can be forced downwardly between the seal ring limbs by any of the usual well known methods (axial movement of the energizing mandrel by electric, hydraulic or mechanical means), thus moving the outer seal ring limb to its full line position, and setting up the seal ring and mandrel tip compressive stresses and the sealing contact forces.

The compressive loading of the mandrel tip in the energized condition is arranged to be at a level maintaining it in the pseudo-elastic range of its stress-strain curve. The super-elastic nature of the alloy therefore permits the energizing mandrel to exert a near constant load on the sealing ring even under differing strains, i.e., the mandrel or other components may move slightly, e.g., due to settling or thermal effects; however the compressive load exerted on the sealing ring limbs will not be significantly affected. Hence the sealing contact forces can be maintained more reliably.

The use, in an energizing mandrel or seal backup spring, of shape memory alloys in their austenitic state whereby they exhibit pseudo-elastic properties can allow energized seals of substantially any known configuration to be used more reliably.

A seal component according to the present invention can be used not only to seal between a tubing hanger and well system, but also to statically and dynamically seal other applications such as shafts, pipes, couplings, joints, flanges, pistons, bores and further apparatus wherein a fluid medium is to be contained and not allowed to leak to the atmosphere or another chamber.

The embodiment shown in FIG. 3 is similar to the previously described embodiment. However, in this instance the SMA is incorporated within the sealing element rather than the mandrel. The sealing ring 10 can be heated so as to move it from the crushed state A (in which it has the necessary clearance for installation next to the well system spool 20) to the energized condition B. Alternatively, the energizing mandrel 24 may posses the necessary wedging surfaces (not shown) so that by relative downward movement it expands and energizes the sealing ring 10 in the well known ordinary manner. In the case where the sealing ring 10 is heated, the mandrel 24 merely acts as a seal ring retainer and can even be omitted if the sealing ring is otherwise retained on the tubing hanger 22 for running in hole. This embodiment can utilize either “one way” or “two way” shape memory alloys.

One-Way SMA (A-B-STRIP OUT)

With the one-way shape memory alloy, it is possible to run the sealing element into the seal bore in a cold and “crushed” state (A). Once in the correct position, heat is applied and the SMA recovers to its “hot” shape and is thereby energized to form the seal (B). In this case, the sealing ring must be stripped out of the bore, as there is no way to regain shape (A) by heat application. When energized, the sealing ring 10 is compressed so as to be maintained in the pseudo-elastic condition, thereby tolerating substantial movements without disruption of the sealing contact forces.

Two-Way SMA (A-B-A)

Two way memory effect refers to the memorization of two shapes. A cold shape is spontaneously obtained during cooling. Different from the one way memory effect, no external forces are required for obtaining the memorized cold shape. During subsequent heating the original hot shape is restored. The two way memory effect is only obtained after a specific thermo-mechanical treatment, called training, in which recovery stresses are built into the “cold shape”. This treatment can be given by the SMA supplier. In use, heat is applied to the sealing ring during running into the bore so that the “hot” shape allows clearance (A). Removal of the heat is followed by a recovery to the “cold” shape and the seal is formed (B). Application of heat moves the material into its “hot” shape and retrieval is possible (A).

The shape memory effects described for the previous embodiments require temperature changes. In contrast, the pseudo-elastic effect is isothermal in nature and involves the storage of potential energy. Isothermal loading of the shape memory element in the “hot shape condition” results in large reversible deformations (up to 8%) at nearly constant stress levels. The alloy exhibits pseudo-elasticity and a near constant stress can be maintained over a large range of strain. The deformations are completely recovered at a lower stress level during unloading. These stress levels are alloy and temperature dependant. In general, the stress levels increase linearly with temperature (215 MPa/K). The elasticity of NiTi is approximately ten times that of steel.

The embodiment of FIG. 4 exploits the pseudo-elastic effect by using a mandrel 24 to deform an SMA sealing ring 10 out into an undercut bore 26 in the well system spool 20 to effect a seal. The solid annular sealing ring 10 has a pair of outer peripheral bumps or ridges 12 and a similar pair of bumps or ridges 14 in its bore. In the energized state, the bumps 12 establish sealing contact with the bore 26 and the bumps 14 with the mandrel 24. The mandrel 24 in turn possesses a sealing ridge or bump 28 that makes sealing contact with the tubing hanger 22. When energized, the sealing ring 10 is maintained in radial compression between the mandrel 24 and bore 26. The potential energy generated is retained within the sealing ring 10 until the mandrel is removed. The sealing ring 10 is thus maintained in a super-elastic state in which the sealing contact forces at the bumps 12, 14, 28 are not easily disrupted. Removal of the mandrel permits the seal to return to its original shape, i.e., clear of the bore 26, for removal.

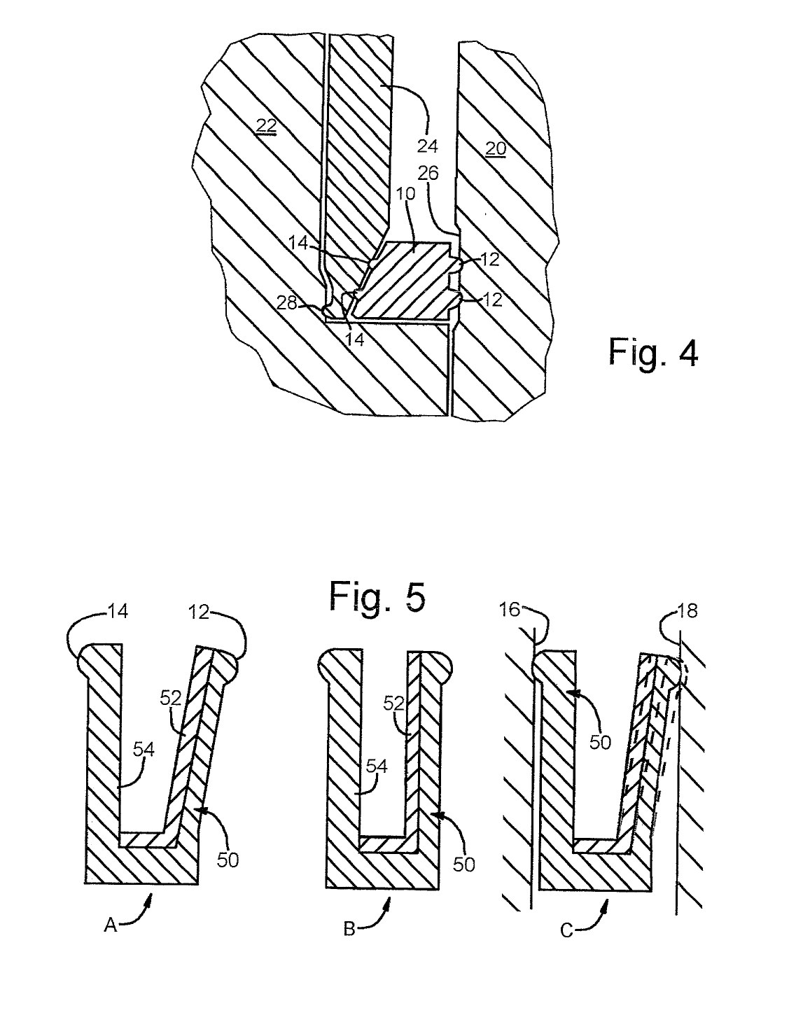

The embodiment shown in FIG. 5 again seeks to overcome the unreliability of previous energized metal seals attributable to their inability to store energy in the system to cope with movement of any of the components. It comprises a bi-metallic composite sealing element 50 that when properly installed between two metallic surfaces, such as between a tubing hanger and well system, will establish and maintain a metal-to-metal fluid-tight sealing system between those surfaces under both static and dynamic conditions, in the presence of corrosive materials, and during and after exposure to a wide range of temperatures.

Similarly to FIG. 2, the sealing element 50 comprises an annular metallic member of U-shaped cross-section, with at least one sealing bump 12 around its outer periphery and at least one sealing bump 14 around its inner surface. The number and configuration of the bumps can again be varied as desired. Material 52 with a relatively lower coefficient of thermal expansion is fused or otherwise bonded to the remaining part 54 of the sealing element 50. Alternatively, material 52 may have a larger coefficient of thermal expansion than material 54.

This sealing element has a linear response to temperature, making sealing difficult under fluctuating well temperatures. It is therefore manufactured as a bi-metallic shape memory alloy sealing element. This is installed in the “crushed” condition (B), and heating above the SMA transition temperature causes the sealing element to try to recover its as-machined shape (A) and form the seal as a result of the shape memory effect. In its installed position (C), the sealing element remains under compression between the co-operating sealing surfaces to provide the necessary sealing contact forces, with the super-elastic effect ensuring that those forces are maintained even under extreme conditions. For removal, the seal would be heated or cooled to enable the bi-metallic effect (differential thermal expansion) to pull the outer leg away from the co-operating sealing surface (B).

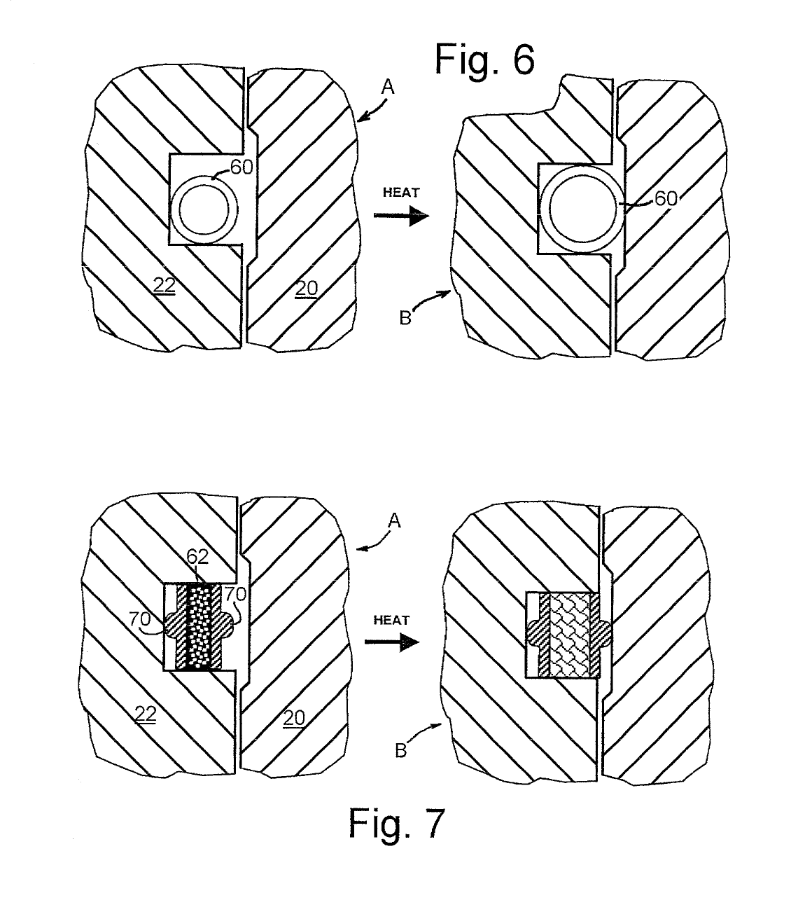

FIGS. 6 and 7 are variants showing different SMA sealing element profiles, in which a seal is obtained due to expansion of the SMA from a “cold shape” condition (A) to the “hot shape” condition (B). FIG. 6 shows an O-ring profile 60 which expands to fill an annular cavity on local application of heat. FIG. 7 shows a composite SMA/corrosion resistant alloy seal, expanding radially only, so that the corrosion resistant alloy 70 forms the seal. The corrosion characteristics of the SMA 62 are therefore not so critical (subject to the SMA being fully encapsulated).

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

What is claimed is:

1. A metallic seal component comprising an alloy which in use exhibits super-elastic properties.

2. A seal component as defined in claim 1 comprising a shape memory alloy.

3. A seal component as defined in claim 2 comprising an energizing mandrel.

4. A seal component as defined in claim 2 comprising a seal backup spring.

5. A seal component as defined in claim 1 comprising a sealing element.

6. A seal component as defined in claim 5 in which the sealing element comprises a sealing ring.

7. A seal component as defined in claim 5 in which the sealing element comprises a sealing ridge that, in use, makes sealing contact with a cooperating sealing surface.

8. A seal component as defined in claim 5 in which the sealing element has a U-shaped cross-section.

9. A seal component as defined in claim 2 in which the shape memory alloy is selected from the group consisting of NiTi, CuZnAl and CuAlNi.

10. A seal component as defined in claim 1 which in use is stressed so as to maintain a sealing contact force with a co-operating sealing surface.

11. A seal component as defined in claim 1 that in use changes its shape or size between an energized, seal enabling state and a released, unsealed state, the change of shape or size being effected by heating or cooling.

12. A seal component as defined in claim 11 which when energized is stressed so as to generate sealing contact forces.

13. A seal component as defined in claim 11 having thermo-mechanical properties such that under ambient conditions in use the component is stressed so as to generate sealing contact forces.

14. A seal component as defined in claim 1 comprising a one-way shape memory alloy.

15. A seal component as defined in claim 1 comprising a two-way shape memory alloy.

16. A seal component as defined in claim 1 comprising a bi-metallic construction.

17. A seal component as defined in claim 16 having a U-shaped cross-section.

18. A seal component as defined in claim 1 having a tubular cross-section.

19. A bi-metallic seal element comprising a shape memory alloy.
